(19) United States
(12) Patent Application Publication
(10) Pub. No.: US 2018/0345753 A1
(43) Pub. Date: Dec. 6, 2018

(54) SYSTEM, METHOD AND COMPUTER PROGRAM FOR THERMAL CONTROL

(71) Applicant: Jaguar Land Rover Limited, Whitley, Coventry, Warwickshire (GB)

(72) Inventor: Neil BELOE, Whitley, Coventry (GB)

(21) Appl. No.: 15/780,180

(22) PCT Filed: Nov. 11, 2016
(86) PCT No.: PCT/EP2016/077444

§ 371 Date: May 30, 2018

(30) Foreign Application Priority Data
Jan. 12, 2016 (GB) 1600535.7

(51) Int. Cl. B60H 1/00; B60N 2/56; H05B 1/02

(52) U.S. Cl. CPC B60H 1/00285; B60H 1/00742; H05B 1/0238; B60H 1/00964; B60N 2/56; B60H 1/00892

(57) ABSTRACT

A system (10) comprising: •means for determining the heat flux (12) from or to an occupant (14) of a seat (16); and •means for controlling heating means (18) and/or cooling means (20) in dependence upon determined heat flux (12) from or to the occupant of the seat.

### TECHNICAL FIELD

The present disclosure relates to a system, method and computer program for thermal control. In particular, but not exclusively it relates to a system, method and computer program for thermal control in a vehicle.

Aspects of the invention relate to a system, a method, a computer program, a vehicle control system and a vehicle.

### BACKGROUND

In some conventional thermal control systems, heating or cooling is controlled by monitoring temperature and controlling the amount of energy to achieve a set temperature point. For example, in some conventional thermal control systems in a vehicle, the current means of heating and/or cooling seats provides a source of energy that is controlled by a controller to monitor a temperature of the seat and control the energy to achieve a set temperature point for the seat.

In some examples, the seat heating or cooling controller can provide a number of set point temperatures for an occupant to select a value which suits their taste. However, it is unlikely that any one value will satisfy the occupant continuously and will therefore become too hot or too cold for the occupant.

It is an aim of the present invention to address disadvantages associated with the prior art.

### SUMMARY OF THE INVENTION

Aspects and embodiments of the invention provide a system, a method, a computer program, a vehicle system and a vehicle as claimed in the appended claims.

According to an aspect of the invention, there is provided a system comprising:
means for determining the heat flux from or to an occupant of a seat; and
means for controlling heating means and/or cooling means in dependence upon determined heat flux from or to the occupant of the seat.

Determining the heat flux from or to an occupant of a seat may comprise controlling measuring of heat flux from or to an occupant of a seat.

A system as described above, wherein:
the means for determining the heat flux and the means for controlling heating means and/or cooling means comprises an electronic processor and an electronic memory device electrically coupled to the electronic processor and having instructions stored therein, the processor being configured to access the memory device and execute the instructions stored therein such that it is operable to control measuring of heat flux and control heating means and/or cooling means.

The heating means may be one or more heaters or heating devices or heating apparatuses.

The cooling means may be one or more coolers or chillers or cooling devices or cooling apparatuses.

The seat may be in a vehicle and the occupant may be an occupant of the vehicle.

The system may comprise means for receiving at least one signal from at least one conductive heat flux sensor, the at least one signal comprising information to enable measuring of, at least, conductive heat flux from or to the occupant of the seat.

The means for receiving at least one signal from at least one conductive heat flux sensor may comprise an electronic processor having an electrical input for receiving said at least one signal from at least one conductive heat flux sensor; and an electronic memory device electrically coupled to the electronic processor and having instructions stored therein for execution by the electronic processor.

The system may comprise means for receiving at least one signal from at least one additional sensor.

The means for receiving at least one signal from at least one additional sensor may comprise an electronic processor having an electrical input for receiving said at least one signal from at least one additional sensor; and an electronic memory device electrically coupled to the electronic processor and having instructions stored therein for execution by the electronic processor.

The at least one signal from the at least one additional sensor may comprise information to enable measuring of radiant energy flux and/or measuring of convective energy flux to the occupant of the seat.

The means for controlling heating means and/or cooling means may comprise means for controlling heating means and/or cooling means in dependence upon, at least, the conductive heat flux from or to the occupant of the seat and the radiant energy flux and/or convective energy flux to the occupant of the seat.

The system may comprise means for controlling the heating means and/or cooling means to provide initial heating and/or cooling to the occupant of the seat prior to the heating means and/or cooling means being controlled in dependence upon the determined heat flux from or to the occupant of the seat.

The means for controlling the heating means and/or cooling means to provide initial heating and/or cooling may comprise an electronic processor and an electronic memory device electrically coupled to the electronic processor and having instructions stored therein, the processor being configured to access the memory device and execute the instructions stored therein such that it is operable to control the heating means and/or cooling means to provide initial heating and/or cooling.

The system may comprise means for receiving at least one initiation control signal, and the means for controlling the heating means and/or cooling means to provide initial heating or cooling may be for controlling the heating means and/or cooling means to provide the initial heating or cooling in dependence upon the at least one initiation control signal.

The means for receiving at least one initiation control signal may comprise an electronic processor having an electrical input for receiving said at least one initiation control signal; and an electronic memory device electrically coupled to the electronic processor and having instructions stored therein for execution by the electronic processor.

The system may comprise means for receiving at least one first signal from a first heat flux sensor, the at least one first signal comprising information to enable a first heat flux from or to the occupant at a first location on the occupant's body to be determined;
means for receiving at least one second signal from a second heat flux sensor, the at least one second signal comprising information to enable the heat flux from or to the occupant at a second, different location on the occupant's body to be determined;
means for controlling first heating means and/or cooling means in dependence upon the first heat flux; and
means for controlling second heating means and/or cooling means in dependence upon the second heat flux.

A system as described above, wherein:
the means for receiving at least one first signal from a first heat flux sensor and the means for receiving at least one second signal from a second heat flux sensor comprises an electronic processor having one or more electrical inputs for receiving the at least one first signal and the at least one second signal; and
an electronic memory device electrically coupled to the electronic processor and having instructions stored therein,
the means for controlling first heating means and/or cooling means in dependence upon the first heat flux and the means for controlling the second heating means and/or cooling means in dependence upon the second heat flux comprises the processor being configured to access the memory device and execute the instructions stored therein such that it is operable to control the first heating means and/or cooling means and the second heating means and/or cooling means.

According to another aspect of the invention, there is provided a system comprising:
means for controlling measuring of heat flux from or to an occupant of a seat; and
means for controlling heating means and/or cooling means in dependence upon measured heat flux from or to the occupant of the seat.

According to another aspect of the invention, there is provided a vehicle control system comprising at least one system as recited in any of the preceding paragraphs.

According to yet another aspect of the invention, there is provided a vehicle comprising at least one system as recited in any of the preceding paragraphs and/or at least one vehicle control system as recited in any of the preceding paragraphs.

According to a further aspect of the invention, there is provided a method comprising:
determining the heat flux from or to an occupant of a seat; and
controlling heating means and/or cooling means in dependence upon determined heat flux from or to the occupant of the seat.

Determining the heat flux from or to an occupant of a seat may comprise controlling measuring of heat flux from or to an occupant of a seat.

The seat may be in a vehicle and the occupant may be an occupant of the vehicle.

The method may comprise receiving at least one signal from at least one conductive heat flux sensor, the at least one signal comprising information to enable measuring of, at least, conductive heat flux from or to the occupant of the seat.

The method may comprise receiving at least one signal from at least one additional sensor.

The at least one signal from the at least one additional sensor may comprise information to enable measuring of radiant energy flux and/or measuring of convective energy flux to the occupant of the seat.

The method may comprise controlling heating means and/or cooling means in dependence upon, at least, the conductive heat flux from or to the occupant of the seat and the radiant energy flux and/or convective energy flux to the occupant of the seat.

The method may comprise controlling the heating means and/or cooling means to provide initial heating and/or cooling to the occupant of the seat prior to controlling the heating means and/or cooling means in dependence upon the determined heat flux from or to the occupant of the seat.

The method may comprise receiving at least one initiation control signal, wherein controlling the heating means and/or cooling means to provide initial heating and/or cooling comprises controlling the heating means and/or cooling means to provide the initial heating and/or cooling in dependence upon the at least one initiation control signal.

The method may comprise

receiving at least one first signal from a first heat flux sensor, the at least one first signal comprising information to enable a first heat flux from or to the occupant at a first location on the occupant's body to be determined;
receiving at least one second signal from a second heat flux sensor, the at least one second signal comprising information to enable the heat flux from or to the occupant at a second, different location on the occupant's body to be determined;
controlling first heating means and/or cooling means in dependence upon the first heat flux; and
controlling second heating means and/or cooling means in dependence upon the second heat flux.

According to a still further aspect of the invention there is provided a system comprising:

means for determining the heat flux from or to one or more people; and

means for controlling heating means and/or cooling means in dependence upon determined heat flux from or to the one or more people.

A system as described above, wherein:
the means for determining the heat flux and the means for controlling heating means and/or cooling means comprises an electronic processor and an electronic memory device electrically coupled to the electronic processor and having instructions stored therein, the processor being configured to access the memory device and execute the instructions stored therein such that it is operable to control measuring of heat flux and control heating means and/or cooling means.

The heating means may be one or more heaters or heating devices or heating apparatuses.

The cooling means may be one or more coolers or chillers or cooling devices or cooling apparatuses.

According to another aspect of the invention there is provided a method comprising controlling heat transfer to or from one or more people in dependence upon determined heat flux from or to the one or more people.

According to a still further aspect of the invention, there is provided a system comprising means for performing the method as described in any of the preceding paragraphs.

The means may comprise an electronic processor and an electronic memory device electrically coupled to the electronic processor and having instructions stored therein, the means for performing the method comprises the processor being configured to access the memory device and execute the instructions stored therein such that it is operable to perform the method as described in any of the preceding paragraphs.

According to yet another aspect of the invention, there is provided a computer program comprising instructions that, when executed by one or more processors, cause a system to perform, at least:
determining the heat flux from or to an occupant of a seat; and
controlling heating means and/or cooling means in dependence upon determined heat flux from or to the occupant of the seat.

According to another aspect of the invention, there is provided a computer program comprising instructions that, when executed by one or more processors, cause a system to perform, at least, a method as recited in any of the preceding paragraphs.

According to a further aspect of the invention, there is provided a non-transitory computer readable media comprising a computer program as described in any of the preceding paragraphs.

According to yet another aspect of the invention, there is provided a seat comprising a system as described in any of the preceding paragraphs.

According to a still further aspect of the invention, there is provided a vehicle control comprising a system as described in any of the preceding paragraphs.

The vehicle control may comprise a steering wheel. The steering wheel may be a heated and/or cooled steering wheel whose temperature control is managed by a system, an apparatus, a device or a method as described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of a system;

FIG. 2 illustrates an example of a system;

FIG. 3 illustrates an example of a method;

FIG. 4 illustrates an example of a method;

FIG. 5 illustrates an example of a system;

FIG. 6 illustrates an example of a system;

FIG. 7 illustrates an example of a system; and

FIG. 8 illustrates an example of a vehicle comprising a system.

### DETAILED DESCRIPTION

Examples of the present disclosure relate to thermal control.

In examples, a system may determine the heat flux, for example using one or more heat flux sensors, from or to an occupant of a seat. In examples, the system may also control heating means and/or cooling means in dependence upon determined heat flux from or to the occupant of the seat.

For example, the system may determine heat flux from or to an occupant of a seat in a vehicle and may control heating means and/or cooling means in the seat in dependence upon determined heat flux from or to the occupant of the seat.

That is, in examples, heating and/or cooling of an occupant of a seat is controlled in dependence upon determined heat flux from or to the occupant of the seat.

As used herein, determine heat flux is intended to include any suitable method for determining heat flux, for example direct measurement, calculation from temperature sensor information and so on. However, it should be noted that the use of heat flux is not a proxy for the use of temperature.

A technical effect of at least some examples of the disclosure is that the flow of energy to or from an occupant of a seat may be controlled in a more predictable manner, avoiding overcooling or overheating. This provides for greater comfort and control for the occupant.

Another technical effect provided by examples of the disclosure is that the amount of energy used by a heating and/or cooling system is reduced. This may be particularly beneficial for battery powered vehicles for example.

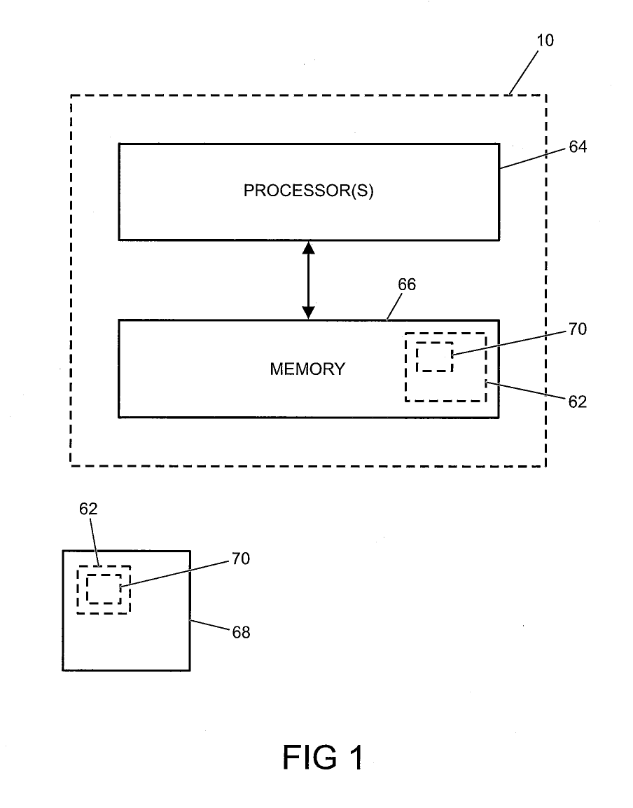

FIGS. 1, 2, 5, 6 and 7 illustrate a system 10 comprising: means for determining the heat flux 12 from or to an occupant 14 of a seat 16; and means for controlling heating means 18 and/or cooling means 20 in dependence upon determined heat flux 12 from or to the occupant 14 of the seat 16.

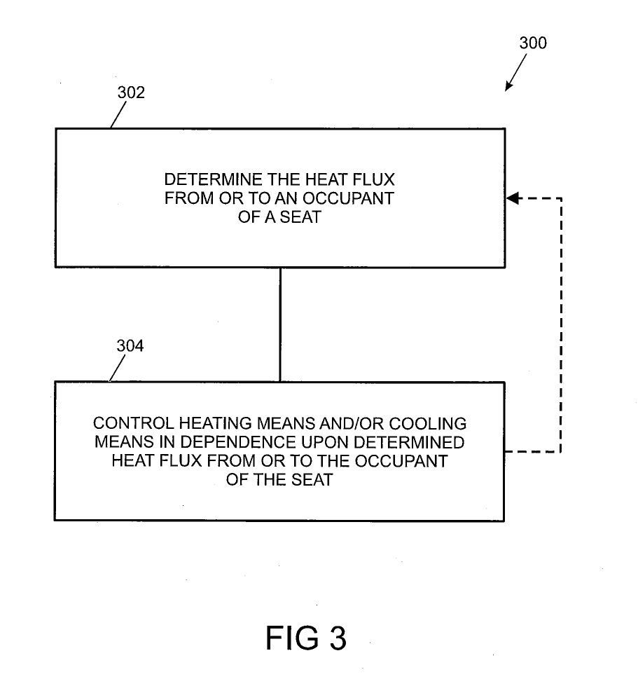

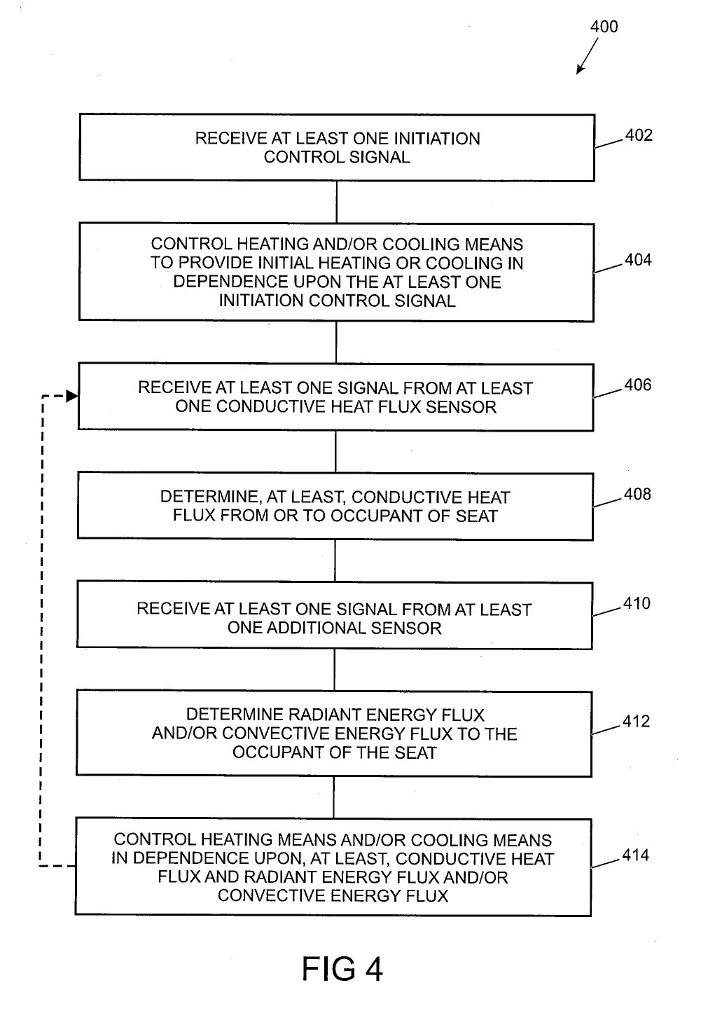

FIGS. 3 and 4 illustrate a method 300, 400 comprising: determining the heat flux 12 from or to an occupant 14 of a seat 16; and controlling heating means 18 and/or cooling means 20 in dependence upon determined heat flux 12 from or to the occupant 14 of the seat 16.

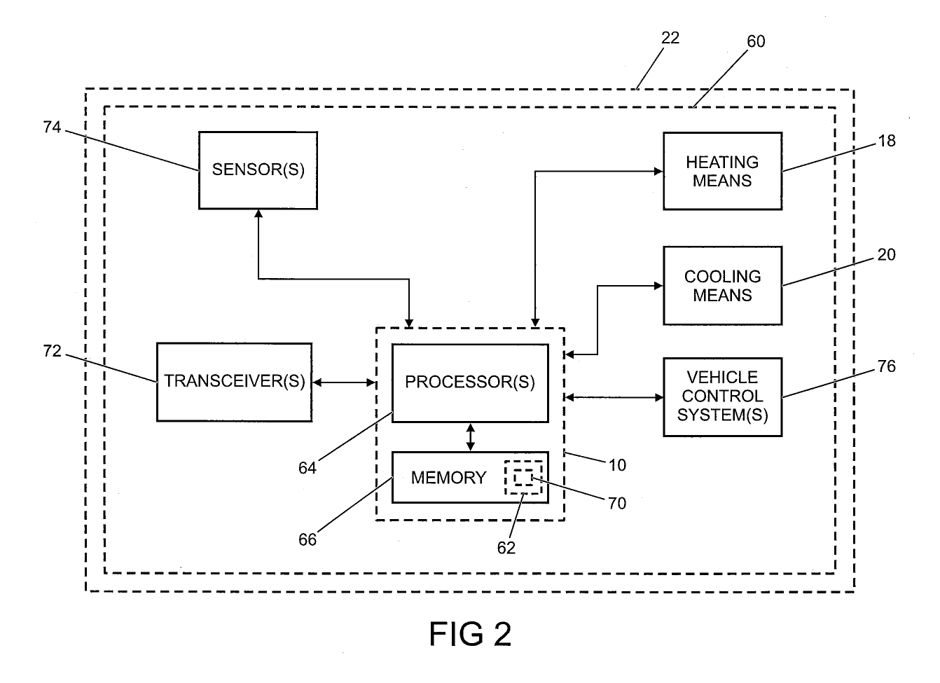

FIGS. 1 and 2 illustrate a computer program 62 comprising instructions 70 that, when executed by one or more processors 64, cause a system 10 to perform, at least: determining the heat flux 12 from or to an occupant 14 of a seat 16; and controlling heating means 18 and/or cooling means 20 in dependence upon determined heat flux 12 from or to the occupant 14 of the seat 16.

FIG. 1 illustrates an example of a system 10 that may be a chip or a chipset. The system 10 may form part of one or more systems comprised in a vehicle 22. For example the system 10 may form part of one or more vehicle control systems 60, such as the one illustrated in the example of FIG. 2.

Implementation of a system 10 may be as controller circuitry. The system 10 may be implemented in hardware alone, have certain aspects in software including firmware alone or can be a combination of hardware and software (including firmware).

As illustrated in FIG. 1 the system 10 may be implemented using instructions that enable hardware functionality, for example, by using executable instructions of a computer program 62 in a general-purpose or special-purpose processor 64 that may be stored on a computer readable storage medium (disk, memory etc.) to be executed by such a processor 64.

The processor 64 is configured to read from and write to the memory 66. The processor 64 may also comprise an output interface via which data and/or commands are output by the processor 64 and an input interface via which data and/or commands are input to the processor 64.

The memory 66 stores a computer program 62 comprising computer program instructions (computer program code) that controls the operation of the system 10 when loaded into the processor 64. The computer program instructions 70, of the computer program 62, provide the logic and routines that enables the apparatus to perform the methods illustrated in FIGS. 3 and 4. The processor 64 by reading the memory 66 is able to load and execute the computer program 62.

The system 10 therefore comprises:

at least one processor 64; and
at least one memory 66 including computer program code
the at least one memory 66 and the computer program code configured to, with the at least one processor 64, cause the system 10 at least to perform:
determining the heat flux from or to an occupant of a seat; and
controlling heating means and/or cooling means in dependence upon determined heat flux from or to the occupant of the seat

As illustrated in FIG. 1, the computer program 62 may arrive at the system 10 via any suitable delivery mechanism 68. The delivery mechanism 68 may be, for example, a non-transitory computer-readable storage medium, a computer program product, a memory device, a record medium such as a compact disc read-only memory (CD-ROM) or digital versatile disc (DVD), or an article of manufacture that tangibly embodies the computer program 62. The delivery mechanism may be a signal configured to reliably transfer the computer program 62 such as CAN, LIN Flexray and so on. The system 10 may propagate or transmit the computer program 62 as a computer data signal.

Although the memory 66 is illustrated as a single component/circuitry it may be implemented as one or more separate components/circuitry some or all of which may be integrated/removable and/or may provide permanent/semi-permanent/dynamic/cached storage.

Although the processor 64 is illustrated as a single component/circuitry it may be implemented as one or more separate components/circuitry some or all of which may be integrated/removable. The processor 64 may be a single core or multi-core processor. In examples, the functionality of the system 10 may be distributed across several processing units connected by inter function communication.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann or Harvard)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device or a hybrid of these architectures etc.

The blocks illustrated in the FIGS. 3 and 4 may represent steps in a method and/or sections of code in the computer program 62. The illustration of a particular order to the blocks does not necessarily imply that there is a required or preferred order for the blocks and the order and arrangement of the block may be varied. Furthermore, it may be possible for some blocks to be omitted.

In examples, the system 10 of FIG. 1 or the system 60 of FIG. 2 provides means for performing the methods illustrated in FIGS. 3 and 4 and as described herein.

The system 10 may be considered a controller or controllers.

FIG. 2 illustrates an example of a system 60. In the illustrated example the system 60 is a system for thermal control in a vehicle 22.

In examples, the system 60 may be considered a control system. In some, but not necessarily all, examples the system 60 is comprised in a vehicle 22 as in the example of FIG. 2.

In FIG. 2, the system 60 comprises one or more transceivers 72, one or more sensors 74, heating means 18, cooling means 20, one or more vehicle control systems 76 and the system 10 illustrated in FIG. 1. FIG. 2 therefore illustrates a vehicle control system 60 comprising at least one system 10 as illustrated in FIG. 1.

The system 10 provides means for controlling operation of the system 60.

As illustrated in the example of FIG. 2, the elements 72, 74, 18, 20 and 76 are operationally coupled to the system 10 and any number or combination of intervening elements can exist between them (including no intervening elements).

In some examples, the elements 72, 74, 18, 20 and 76 are operationally coupled to each other and/or may share one or more components. For example, the heating means 18 and cooling means 20 may share one or more components.

Additionally or alternatively, the elements 72, 74, 18, 20 and 76 may be operationally coupled to and/or share one or more components with other elements not illustrated in the example of FIG. 2.

The one or more transceivers 72 may be for receiving and/or transmitting one or more signals to/from the system 60. In some examples, the one or more transceivers 72 are for receiving and/or sending one or more signals to/from a vehicle 22. Any suitable transceiver or transceivers may be used and in some examples separate transmitter(s) and/or receiver(s) may be used.

In some, but not necessarily all, examples the one or more transceivers 72 are for transmitting and/or receiving radio frequency signals. The one or more transceivers 72 may be for transmitting and/or receiving radio frequency signals over any suitable range.

In some examples, the one or more transceivers 72 are configured to operate using one or more short-range radio communication protocols, such as Bluetooth® or Wi-Fi® protocols and/or one or more long-range radio protocols such as one or more cellular telephone protocols.

In examples, the one or more transceivers are configured to operate using one or more hard-wired protocols such as CAN and/or LIN and/or Flexray® and so on.

In some examples, the one or more transceivers 72 are for transmitting and/or receiving one or more signals using any suitable communication protocol or protocols such as those mentioned in the preceding paragraphs. The one or more signals transmitted and/or received by the one or more transceivers 72 may include data or information and therefore, in some examples, the system 10 is for controlling the one or more transceivers 72 to send and/or receive one or more signals to send and/or receive data or information.

For example, the transceiver 72 may be for receiving at least one initiation control signal and the system 10 may control the heating means 18 and/or cooling means 20 in dependence upon the received at least one initiation control signal (see, for example, FIG. 4).

In examples, the system 10 is for controlling operation of the one or more transceivers 72. Information may be transmitted between the system 10 and the one or more transceivers 72. For example, control information may be transmitted from the system 10 to the one or more transceivers 72 and/or data/information received in one or more signals transmitted to the system 10. This is illustrated in the example of FIG. 2 by the double-headed arrow linking the one or more transceivers 72 and the system 10.

In examples, the one or more transceivers 72 may be considered to form part of the one or more sensors 74.

The one or more sensors 74 are for obtaining information. For example, the one or more sensors 74 may be for obtaining information in relation to an occupant 14 of a seat 16 in a vehicle 22 (see, for example, FIG. 6).

Additionally or alternatively, the one or more sensors 74 may be for obtaining information regarding the environment, for example, inside or outside of a vehicle 22.

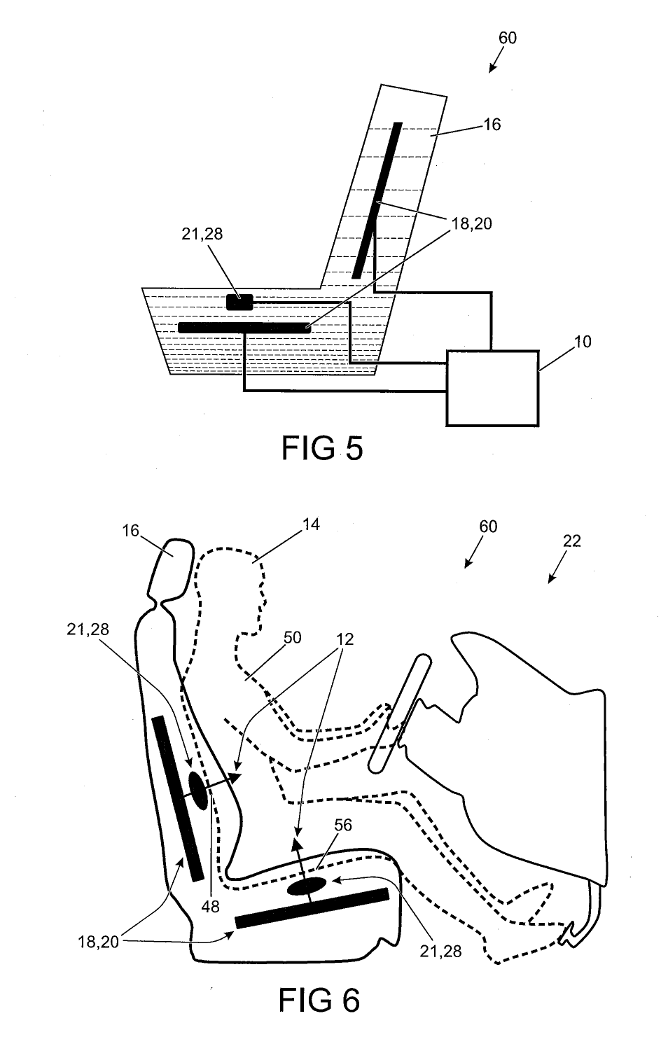

The one or more sensors 74 may comprise any suitable sensor(s) for obtaining information. For example, the one or more sensors 74 may comprise one or more heat flux sensors 21 for measuring or estimating heat flux 12 from or to an occupant 14 of a seat 16 (see, for example, FIGS. 5 to 7). In examples any suitable heat flux sensor 21 for measuring or estimating heat flux 12 from or to an occupant 14 of a seat 16 may be used, for example heat flux sensor(s) 21 based on one or more thermocouples.

The heat flux sensors 21 may be arranged to measure heat flux 12 directly or to provide temperature measurements for a suitable determination/calculation of heat flux 12.

In some examples, the one or more sensors 74 comprise at least one conductive heat flux sensor 28 for measuring or estimating, at least, conductive heat flux from or to the occupant 14 of the seat 16.

For example a heat flux sensor 21 comprising one or more temperature sensors arranged on either side of a piece of material of known conduction characteristics to allow a calculation of the energy flow rate across the material of known conduction characteristics may be used.

In examples, any suitable temperature sensors may be used. For example, thermistors, thermocouples and so on may be used.

Additionally or alternatively, any suitable material of known conduction characteristics may be used. For example a material of known conduction characteristics that forms part of a seat 16 construction may be used. In some examples a part of a seat 16 that is between heating and/or cooling means and a surface of the seat 16 is used.

In examples, the one or more sensors 74 comprise at least one conductive heat flux sensor 28 and at least one additional sensor. For example, the at least one additional sensor may be at least one radiant energy flux sensor for measuring or estimating radiant energy flux to the occupant 14 of the seat 16 and/or at least one convective energy flux sensor for measuring or estimating convective energy flux to the occupant 14 of the seat 16.

Any suitable convective energy flux sensor may be used. For example, any suitable convective energy flux sensor for measuring air temperature may be used. This may provide a measurement or estimation of the convective energy flowing to the occupant 14 of the seat 16 which may be in a vehicle 22.

Any suitable radiant heat flux sensor may be used. For example, any suitable solar sensors may be used to allow a measurement or estimation of the radiant energy flux to the occupant 14 of the seat 16 to be obtained.

In examples, a plurality of heat flux sensors 21 may be used that may be the same or different. For example, a plurality of conductive heat flux sensors 28 and/or plurality of convective energy flux sensors and/or a plurality of radiant energy flux sensors may be used.

In some, but not necessarily all, examples of the disclosure a plurality of heat flux sensors 21, such as conductive heat flux sensors 28, may be used to measure heat flux from or to the occupant 14 of the seat 16 at a plurality of different locations on the occupant's body (see, for example, FIG. 6).

In examples, the system 10 is for controlling operation of the one or more sensors 74. Information may be transmitted between the system 10 and the one or more sensors 74. For example, control information may be transmitted from the system 10 to the one or more sensors 74 and/or information gathered by the one or more sensors 74 transmitted to the system 10.

In examples, one or more signals comprising information may be received by the system 10 from the one or more sensors 74.

The information in the one or more signals may enable determining of heat flux from or to the occupant 14 of the seat 16. For example, the information may enable measuring or estimating of conductive heat flux from or to the occupant 14 of the seat 16 and/or convective energy flux from or to the occupant 14 of the seat 16 and/or radiant energy flux from or to the occupant 14 of the seat 16.

This is illustrated in the example of FIG. 2 by the double-headed arrow linking the one or more sensors 74 and the system 10.

The heating means 18 may be any suitable means for heating or providing heat to an occupant 14 of a seat 16.

In examples, the heating means may provide heat to the occupant 14 of the seat 16 by conduction and/or convection and/or radiation. In examples, the heating means may be considered one or more heaters or heating devices or heating apparatuses.

In examples the heating means comprise one or more electrical heating devices such as electrical resistive heating devices and so on.

Additionally or alternatively the heating means 18 may comprise a plurality of different sources of heat for heating the occupant 14 of the seat 16. For example, the heating means 18 may comprise one or more heating means 18 in one or more locations in the seat 16 and/or one or more heating means 18 in a steering device of a vehicle 22 such as a steering wheel and/or one or more heating means such as a ventilation system. See, for example, FIGS. 5, 6 and 7.

The controlled heating of other surfaces within a vehicle 22 may also be useful. For example, the heating means 18 may be for heating at least one surface of a vehicle such as a seat, steering wheel, door trim, arm rests, floor mats, side panels and so on or any combination thereof.

The heating means 18 may comprise at least part of the heating ventilation and air conditioning (HVAC) system of a vehicle 22.

The heating means 18 may be controlled according to the rate of energy transfer into or out of a seat 16.

In examples, the system 10 is for controlling operation of the heating means 18. Information may be transmitted between the system 10 and the heating means 18. For example, control information may be transmitted from the system 10 to the heating means 18 and/or one or more signals from the heating means 18 may be transmitted to the system 10.

This is illustrated in the example of FIG. 2 by the double-headed arrow linking the heating means 18 and the system 10.

The cooling means 20 may comprise any suitable means for cooling or removing heat from an occupant 14 of a seat 16. In examples the cooling means may be considered one or more coolers or chillers or cooling devices or cooling apparatuses.

In examples the cooling means 20 may remove heat from the occupant of the seat by any suitable method. For example, the cooling means 20 may comprise a cooled fluid to remove heat from the occupant 14 of the seat 16.

In examples the cooling means may comprise one or more Seebeck and/or Peltier devices. In some examples the cooling means may comprise one or more heat conduits or pipes to conduct heat energy away from the occupant of the seat 16.

Additionally or alternatively the cooling means 20 may comprise a plurality of different sinks of heat for cooling the occupant 14 of the seat 16. For example, the cooling means 20 may comprise one or more cooling means 20 in one or more locations in the seat 16 and/or one or more cooling means 20 in a steering device of a vehicle 22 such as a steering wheel and/or one or more air-conditioning systems. See, for example, FIGS. 5, 6 and 7.

The controlled cooling of other surfaces within a vehicle 22 may also be useful. For example, the cooling means 20 may be for cooling at least one surface of a vehicle such as a seat, steering wheel, door trim, arm rests, floor mats, side panels and so on or any combination thereof.

For example, the cooling means 20 may comprise at least part of the heating ventilation and air conditioning (HVAC) system of a vehicle 22.

The cooling means 20 may be controlled according to the rate of energy transfer into or out of a seat 16.

In examples, the system 10 is for controlling operation of the cooling means 20. Information may be transmitted between the system 10 and the cooling means 20. For example, control information may be transmitted from the system 10 to the cooling means 20 and/or one or more signals from the cooling means 20 transmitted to the system 10.

This is illustrated in the example of FIG. 2 by the double-headed arrow linking the cooling means 20 and the system 10.

In examples, the cooling means 20 and heating means 18 may be combined and/or share one or more elements.

The heating means 18 may be considered a heat source and the cooling means 20 may be considered a heat sink.

The one or more vehicle control systems 76 are for controlling any component or components of the vehicle 22.

For example, the one or more vehicle control systems 76 may comprise a heating ventilation and air conditioning (HVAC) control module for controlling heating and air conditioning of the vehicle 22. Accordingly, in some examples the one or more vehicle control systems 76 may control at least part of the heating means 18 and/or cooling means 20.

In other terms, a “module” may be referred to as an electronic control unit (ECU). For example, a HVAC control module may be referred to as a HVAC electronic control unit and so on.

The one or more vehicle control systems 76 may comprise any system that is configured to supply or to remove thermal energy to/from the occupant 14. For example, temperature controlled surfaces such as door trim, arm rests, floor mats, side panels and so on.

The system 10 is for controlling operation of the one or more vehicle control systems 76. Information may be transmitted between the system 10 and the one or more vehicle control systems 76. For example, control information may be transmitted from the system 10 and the one or more vehicle control systems 76 and/or information may be transmitted from the one or more vehicle control systems 76 to the system 10.

In examples, the system 10 provides means for controlling the various elements of the system 60.

In the example of FIG. 2, the system 60 is comprised in a vehicle 22. The vehicle 22 may be any suitable vehicle 22 such as a car, van or truck and so on.

The system 60 may comprise any number of additional elements not illustrated in the example of FIG. 2. Additionally or alternatively, one or more of the elements in the system 60 illustrated in the example of FIG. 2 may be integrated and/or combined. For example, the one or more sensors 74 may be at least partially combined with the one or more transceivers 72. Additionally or alternatively, the heating means 18 may be at least partially combined with the cooling means 20 and so on.

In examples, the system 60 may not comprise one or more of the elements illustrated in the example of FIG. 2. For example, the system 60 may not comprise the one or more transceivers 72.

FIG. 3 illustrates an example of a method 300. For example, the method 300 may be for thermal regulation of an occupant 14 of a seat 16 in a vehicle 22.

The method 300 may be performed by the system 10 of FIG. 1 or the system 60 of FIG. 2.

That is, in examples, the system 10 of FIG. 1 or the system 60 of FIG. 2 comprises means for performing the method 300.

Some of the elements referred to in the discussion of FIG. 3 are found in FIGS. 5, 6 and/or 7.

At block 302, the heat flux 12 from or to an occupant 14 of a seat 16 is determined. The seat 16 may be in a vehicle 22 and the occupant 14 may be an occupant 14 of the vehicle 22.

Any suitable method for determining the heat flux 12 from or to an occupant 14 of a seat 16 may be used.

For example, the one or more sensors 74 of the system 60 illustrated in the example of FIG. 2 may be used to obtain information regarding an occupant 14 of a seat 16 to enable determining of the heat flux 12 from or to the occupant 14 of the seat 16.

In examples, determining the heat flux 12 from or to an occupant 14 of a seat 16 may comprise receiving one or more signals from one or more heat flux sensors 21, the signals comprising information to enable determining of heat flux 12 from or to the occupant 14 of the seat 16 (see FIG. 4).

In some examples, one or more heat flux sensors 21 may be located in the seat 16 to enable determining of the heat flux 12 from or to the occupant 14 of the seat 16 corresponding to into or out of the seat 16.

The one or more heat flux sensors 21 may measure heat flux 12 from or to the occupant 14 at a plurality of different locations on the occupant's body.

As used herein, determining heat flux 12 is intended to include direct measurement, calculation from temperature sensor information and so on.

At block 304, heating means 18 and/or cooling means 20 are controlled in dependence upon determined heat flux 12 from or to the occupant 14 of the seat 16.

For example, the heating means 18 and/or cooling means 20 of the system 60 in the example of FIG. 2 may be controlled in dependence upon the determined heat flux 12 from or to the occupant 14 of the seat 16.

For example, a signal from one or more heat flux sensors 21 may be used to control the current supplied to the heating means 18 and/or cooling means 20 to control the amount of heating and/or cooling provided to the occupant 14 of the seat 16.

It is known that an occupant 14 of a seat 16 will generate heat, for example, via the occupant's metabolism. Accordingly, to remain comfortable, the occupant 14 of the seat 16 must dissipate a certain amount of heat to regulate his or her temperature.

In the examples, the required heat dissipation for an occupant 14 of the seat 16 may be determined by any suitable method. For example, the required heat dissipation may be set at a default value such as 100 Watts or Joules per second. In examples the default value may be varied for different occupants, for example for men and women.

In examples the system 10 may detect, using one or more sensors 74 for example, that the seat is occupied by a child restraint system (CRS)/child seat. In this case the system 10 may control the heating means 18 and/or cooling means 20 differently. For example, the system 20 may deactivate the heating means 18 and/or cooling means 20 to deactivate the thermal regulation system for the seat occupied by the child restraint system/child seat. Alternatively, the system 10 may control the heating means 18 and/or cooling means 20 according to a user selected setting in this case.

In some examples the occupant 14 of the seat 16 may provide an input to the system 10 or system 60 using any suitable means to set the desired heat loss. Additionally or alternatively, a default value of heat loss for an occupant 14 of the seat 16 may be set which may, for example, be altered by an input into the system 10 or system 60.

In examples the required heat dissipation may be calculated by estimating the metabolic rate of the occupant 14 of the seat 16. For example, the one or more sensors 74 may comprise a sensor or sensors configured to measure the heart rate of the occupant 14 and/or the rate at which the occupant is expiring carbon dioxide. In some examples the sensor or sensors may be comprised in one or more mobile and/or wearable devices. For example, a mobile telephone, an activity monitor and so on.

The one or more sensors 74 may also comprise a sensor or sensors, such as an occupant sensing pad in the seat 16, to estimate the size of the occupant of the seat 16. For example, the weight and/or width of the hips of the occupant may be estimated. In this way the system 10 may determine if a child, for example, is the occupant of the seat 16 and may adjust the thermal response accordingly. For example, a high heart rate for an adult, which may indicate a rapid metabolism, may be a normal heart rate for a child.

In some examples, activity history of the occupant 14 may be used in determining the required heat dissipation. For example, information from a mobile device and/or wearable device, such as a mobile telephone or activity monitor, may be used to determine the activity history of the occupant 14 of the seat 16.

In examples, if the heat flux determined at block 302 indicates that too much heat is being dissipated from the occupant 14 of the seat 16, the heating means 18 may be controlled to heat the seat 16, for example, to bring the heat flux from the occupant 14 to the required level.

In examples, the system 10 may only thermally regulate occupied seats in a vehicle 22 or may prioritize the occupied seat(s) in the vehicle 22 for thermal regulation. For example, if a vehicle 22 has been parked in the sun and the seats of the vehicle have become hot through solar loading they may require cooling. However, if only one of the seats of the vehicle is being occupied only the occupied seat may be cooled or the occupied seat may be cooled as a priority over the unoccupied seats. The unoccupied seats may be cooled opportunistically to help bring the vehicle cabin temperature down, for example during periods of re-gen braking and/or at the end of a charging cycle/

In examples, if the heat flux 12 determined at block 302 indicates that insufficient heat is being dissipated by the occupant 14 of the seat 16, the cooling means 20 may be controlled to cool the seat 16, for example, to bring the heat dissipated by the occupant 14 of the seat 16 to the required level.

In some examples, additional information may be used to control the heating means 180 and/or cooling means 20 (see FIG. 4).

In some examples, the required heat dissipation may be tailored to individual occupants 14 of the seat 16. For example, different occupants 14 of the seat 16 may set different required heat fluxes tailored to their individual needs. In examples, this may be achieved by each occupant 14 of the seat 16 setting their own required heat flux level and/or automatic recognition of the occupants 14 of the seat 16.

In some examples, the one or more sensors 74 and or one or more transceivers 72 of the system 60 of FIG. 2 may be used to automatically identify an occupant 14 of a seat 16, such as a driver of a vehicle 22, and automatically set the required heat flux 12 for the recognised occupant 14.

In examples, the one or more sensors 74 may be used in facial recognition, for example, and/or one or more signals may be received from a personal device of the occupant 14, such as a mobile telephone, tablet device, laptop, wearable device and so on, to identify the occupant 14 to the system 10 or system 60.

As the heating means 18 and/or cooling means 20 are controlled in dependence upon the determined heat flux 12 from or to the occupant 14 of the seat 16, this may effect a quick time to comfort for the occupant 14 of the seat 16 without overheating or overcooling of the occupant 14. This is in distinction to conventional systems that control to a particular set temperature which may overheat or overcool an occupant 14 of a seat 16.

In examples an asymmetric approach for heating and cooling may be adopted.

For example, if the occupant 14 of the seat 16 feels hot and the ambient temperature is high then it may be assumed the occupant 14 of the seat 16 is not wearing bulky clothes and so a variation in the temperature of the heating means 18 and/or cooling means 20 will be perceived quickly by the occupant 14.

If the occupant 14 of the seat 16 feels cold and the ambient temperature is low then it may be assumed that the occupant 14 of the seat 16 is well insulated with clothes. Accordingly the heating means 18 may be controlled to warm the occupant 14 of the seat 16 more gradually, or to prioritize heating the occupant 14 where it will be felt first, such as under the thighs.

In some examples a profile of heat flow may be used to achieve the quick time to comfort for the occupant 14 of the seat 16. For example, the required heat loss may be varied over time to compensate for the thermal mass of the seat 16 and/or a physiological pre-condition of the occupant 14, such as when the occupant 14 is hot or cold upon sitting in the seat 16.

This is advantageous also because using heat flux 12 as the means of control allows for the required heat loss for the occupant 14 of the seat 16 to be maintained and therefore the comfort of the occupant 14 to be maintained in an effective and predictable manner. The use of heat flux 12 as the means for control also may allow for a fully automated thermal comfort control system where thermostatic control would not.

This is advantageous also because the heat flux measurement allows a varying of the energy input to an occupant of a seat, rather than having a constant energy input which provides a saving of energy. This may be particularly beneficial in battery powered vehicles for example.

In the example of FIG. 3, a dotted arrow links block 304 back to block 302. This is to indicate that the method may be repeated to regulate the heat flux 12 from the occupant 14 of the seat 16. This allows the comfort of the occupant 14 to be maintained even if the environment of the occupant 14 of the seat 16 changes, requiring greater or less heat flux 12 from the occupant 14.

In examples, the method 300 may be repeated continuously or at a particular interval of time.

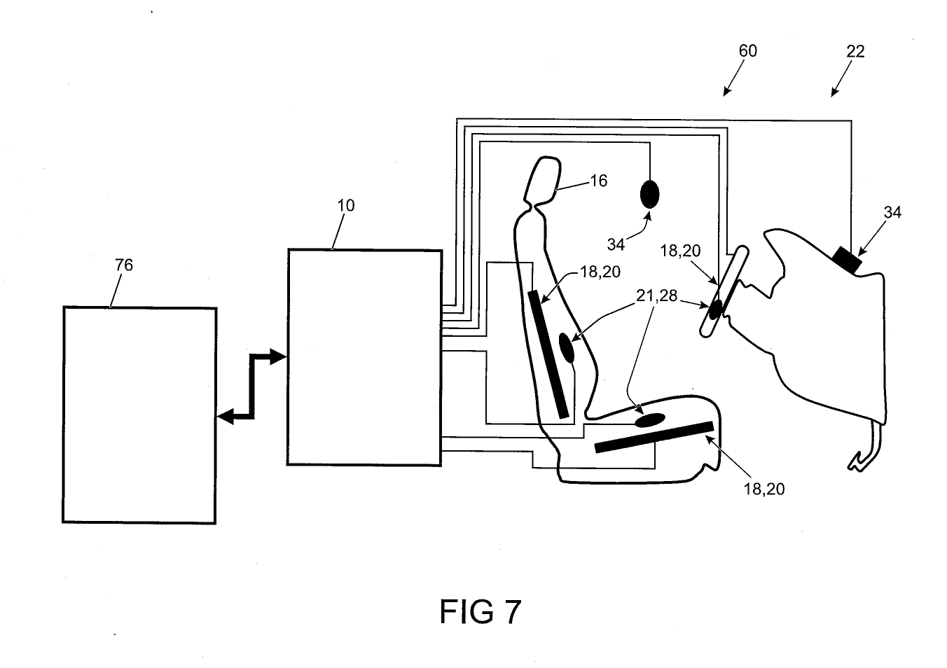

In examples, a plurality of heat flux sensors 21 at different locations may be used to measure heat flux 12 from or to an occupant 14 of the seat 16 at a plurality of different locations on the occupant's body. See, for example, FIGS. 6 and 7.

Accordingly, in examples, the method 300 may comprise receiving at least one first signal from a first heat flux sensor 21, the at least one first signal comprising information to enable a first heat flux 12 from or to the occupant 14 at a first location on the occupant's body to be determined; receiving at least one second signal from a second heat flux sensor 21, the at least one second signal comprising information to enable the heat flux 12 from or to the occupant 14 at a second, different location on the occupant's body to be determined; controlling first heating means 18 and/or cooling means 20 in dependence upon the first heat flux 12; and controlling second heating means 18 and/or cooling means 20 in dependence upon the second heat flux 12.

That is, in examples the method 300 may comprise determining the heat flux 12 from or to an occupant 14 of a seat 16 at a first location 48 of an occupant's body, determining the heat flux 12 from or to the occupant 14 of a seat 16 at a second, different location 56 on the occupant's body, controlling first heating means 18 and/or first cooling means 20 in dependence upon the first heat flux 12 and controlling second heating means 18 and/or cooling means 20 in dependence upon the second heat flux 12.

Accordingly, in examples, a plurality of heat flux sensors 21 may be used to measure the heat flux 12 from the occupant 14 of the seat 16 at different locations on the occupant's body to allow for finer control of the heat flux 12 from the occupant 14.

For example, if the occupant 14 is wearing a thick sweater but only thin trousers, the back of the seat 16 may be heated or cooled differently to the seat cushion of the seat 16 to maintain a comfortable heat dissipation for the occupant 14 despite the different thickness of clothing worn by the occupant 14.

FIG. 4 illustrates an example of a method 400. For example, the method 400 may be for thermal control of an occupant 14 of a seat 16 in a vehicle 22.

The method 400 may be performed by the system 10 of FIG. 1 or the system 60 of FIG. 2.

That is, in some examples, the system 10 of FIG. 1 or the system 60 of FIG. 2 comprises means for performing the method 400.

At block 402, at least one initiation control signal is received. In examples, the at least one initiation control signal may be received from the one or more sensors 74 and/or one or more transceivers 72 of the system 60 in the example of FIG. 2.

The at least one initiation control signal may comprise information for initial controlling of the heating means 18 and/or cooling means 20 before control of the heating means 18 and/or cooling means 20 in dependence upon heat flux 12 from or to the occupant 14 of the seat 16.

In some examples, the at least one initiation control signal may be received by the transceiver 72 of the system 60 from a personal device, such as a mobile telephone, tablet device, laptop, wearable device and so on, of the occupant 14 of the seat 16. For example, the occupant 14 may make an input into the personal device to initially control the heating means 18 and/or cooling means 20 prior to control in dependence upon heat flux 12.

For example, if the occupant 14 is cold, the heating means 18 may be initially controlled to provide heat to the occupant 14 prior to regulating in dependence on heat flux 12 from the occupant 14.

Alternatively, if the occupant 14 is hot, the occupant 14 may provide an input to control the cooling means 20 to cool the occupant 14 prior to regulating in dependence on the heat flux 12 from the occupant 14.

Alternatively, if the occupant 14 is thermoneutral, that is to say, the occupant is substantially is losing heat at the rate that their metabolism is creating it and so they feel neither hot nor cold, then the occupant 14 may provide an input indicating this and the heating means 18 and/or cooling means 20 may be immediately controlled in dependence upon heat flux 12 from or to the occupant 14.

In examples, a pre-programmed profile of required heat loss may be used to compensate for the occupant being hot, cold or thermoneutral upon occupying the seat 16.

In some examples, the requirement for initial heating, cooling or regulating may be assumed from information gathered by the one or more sensors 74. For example, the one or more sensors 74 may measure environmental temperature and send at least one initiation control signal to the system 10 indicating that the occupant 14 is likely to be hot, cold or thermoneutral to control initial heating or cooling of the occupant 14.

Additionally or alternatively, a personal device of the occupant 14 may monitor if the occupant has been partaking in physical exercise, for example, and transmit at least one initiation control signal to control the cooling means 20 initially to cool the occupant 14 following the physical exercise.

In some examples the initial heating or cooling may be set as a default.

In general, any suitable method for providing the at least one initiation control signal may be used. As mentioned above, this may include an input from the occupant 14 and/or information on the thermal state of the occupant 14 upon sitting in the seat 16 to initialise the system 10 or system 60. In some examples the heating means 18 and/or cooling means 20 may be initiated prior to the occupant 14 occupying the seat 16 to take into account the thermal mass of the seat 16 itself. This may provide pre-heating or pre-cooling for the occupant 14.

At block 404, heating means 18 and/or cooling means 20 are controlled to provide initial heating and/or cooling to the occupant 14 of the seat 16 prior to controlling the heating means 18 and/or cooling means 20 in dependence upon determined heat flux 12 from or to the occupant 14 of the seat 16 in dependence upon the at least one initiation control signal.

In examples, the heating means 18 and/or cooling means 20 are controlled to provide initial heating and/or cooling to the occupant 14 of the seat 16 prior to controlling the heating means 18 and/or cooling means 20 in dependence upon determined heat flux 12 from or to the occupant 14 of the seat 16.

For example, the heating means 18 and/or cooling means 20 of the system 60 illustrated in FIG. 2 may be controlled to provide initial heating and/or cooling to the occupant 14 of the seat 16 in dependence upon the at least on initiation control signal received at block 402.

In examples, the heating means 18 and/or cooling means 20 may be controlled to provide initial heating and/or cooling in dependence upon the at least one initiation control signal for a set period of time. The set period of time may be set by the occupant 14 or may be a default period of time. The period of time may be set by any suitable method.

After the period of time has elapsed, the method proceeds to block 406.

At block 406, at least one signal from at least one conductive heat flux sensor 28 is received.

For example, the at least one conductive heat flux sensor 28 may be comprised in the at least one sensors 74 of the system 60 illustrated in FIG. 2.

In examples, the at least one signal from the at least one conductive heat flux sensor 28 enables determining of, at least, conductive heat flux from or to the occupant 14 of the seat 16.

Conductive heat flux may be considered to be/include conductive energy flux and the at least one conductive heat flux sensor 28 may be considered at least one conductive energy flux sensor.

In examples, the at least one signal received from the at least one conductive heat flux sensor 28 may enable estimation of, at least, conductive heat flux from or to the occupant 14 of the seat 16.

For example, the at least one signal received from the at least one conductive heat flux sensor 28 may comprise information to enable determining or estimating of, at least, the conductive heat flux from or to the occupant 14 of the seat 16.

In examples, at least one signal may be received from a plurality of conductive heat flux sensors 28 to enable determining or estimation of, at least, conductive heat flux from or to the occupant 14 of the seat 16 at a plurality of locations on the occupant's body. See, for example, FIGS. 5 to 7.

At block 408, at least conductive heat flux from or to the occupant 14 of the seat 16 is determined.

In examples, this may comprise using or manipulating information received in the at least one signal at block 406 to obtain one or more measurements of conductive heat flux from or to the occupant 14 of the seat 16.

In some examples, receiving at least one signal from at least one conductive heat flux sensor 28 may be considered part of determining the, at least, conductive heat flux from or to the occupant 14 of the seat 16. That is, in some examples, block 406 may be considered to be part of block 408.

In general, determining the heat flux 12 from or to an occupant 14 of a seat 16 may be considered to comprise receiving at least one signal from at least one heat flux sensor 21.

At block 410, at least one signal from at least one additional sensor 34 is received.

In examples, the at least one additional sensor 34 may be comprised in the one or more sensors 74 of the system 60 illustrated in FIG. 2.

The at least one signal received from the at least one additional sensor 34 may comprise information to enable determining or estimation of radiant energy flux and/or determining or estimation of convective energy flux to the occupant 14 of the seat 16. In examples radiant energy flux may be considered to be/include radiant heat flux and convective energy flux may be considered to be/include convective heat flux.

For example, the at least one additional sensor 34 may be an air sensor for determining air temperature in a vehicle 22 to allow measurement or estimation of convective energy flux to the occupant 14 of the seat 16 and/or a solar sensor to allow measurement or estimation of radiant energy flux to the occupant 14 of the seat 16.

In examples, any suitable additional sensor(s) may be used.

At block 412 radiant energy flux and/or convective energy flux to the occupant 14 of the seat 16 is determined.

In examples, the at least one signal from the at least one additional sensor 34 comprises information to enable determining of radiant energy flux and/or determining of convective energy flux to the occupant 14 of the seat 16.

In examples, receiving at least one signal from at least one additional sensor 34, such as an air sensor and/or solar sensor, may be considered part of determining the radiant energy flux and/or determining of convective energy flux to the occupant 14 of the seat 16. That is, in examples, block 410 may be considered part of block 412.

At block 414, heating means 18 and/or cooling means 20 are controlled in dependence upon, at least, conductive heat flux from or to the occupant 14 of the seat 16 and radiant energy flux and/or convective energy flux to the occupant 14 of the seat 16.

In examples, the heating means 18 and/or cooling means 20 may be the heating means 18 and/or cooling means 20 of the system 60 illustrated in the example of FIG. 2.

In examples, a conductive heat flux measurement or estimation, a radiant energy flux measurement or estimation and a convective energy flux measurement or estimation may be used to determine total energy flux from or to the occupant 14 of the seat 16.

This may allow determination of the energy dissipation required by the occupant 14 of the seat 16 to maintain a comfortable heat dissipation as described in relation to FIG. 3.

That is, the conductive, radiant and convective energy flux measurements or estimations may allow for an energy flux calculation with regard to the occupant 14 of the seat 16 to be determined.

The heating means 18 and/or cooling means 20 may be controlled in dependence upon these measurements to provide the required heat dissipation for the occupant 14 of the seat 16 to maintain comfort for the occupant 14 of the seat 16.

For example, if it is determined that it is a particularly sunny day and therefore the occupant 14 of the seat 16 is receiving a large amount of energy in the form of radiation from the sun, the heating means 18 and/or cooling means 20 may be controlled to provide greater heat dissipation from the occupant 14 of the seat 16 to take into account the radiant energy flowing to the occupant 14 of the seat 16.

In another example, if it is determined that the air temperature in the vehicle 22, for example, is high, the convective energy flowing to the occupant 14 may be determined to also be high and again the heating means 18 and/or cooling means 20 may be controlled to provide heat dissipation from the occupant 14 taking into account the convective energy flowing to the occupant 14.

In general, the conductive heat flux, radiant energy flux and convective energy flux measurements or estimations may allow a more complete determination of the required heat dissipation from the occupant 14 of the seat 16 to provide a comfortable environment for the occupant 14 of the seat 16.

Control of the heating means 18 and/or cooling means 20 in dependence upon the determined heat flux 12 from or to the occupant 14 of the seat 16 may be as described in relation to block 304 of FIG. 3.

In the example of FIG. 4, a dotted arrow links block 414 back to block 406. This is to indicate that blocks 406 to 414 of method 400 may be repeated to regulate the heat flux 12 from the occupant 14 of the seat 16. This allows the comfort of the occupant 14 to be maintained even if the environment of the occupant 14 of the seat 16 changes, requiring greater or less heat flux 12 from the occupant 14.

In examples, the method 400 may be repeated continuously or at a particular interval of time.

In examples, a plurality of heat flux sensors 21 at different locations may be used to measure heat flux 12 from or to an occupant 14 of the seat 16 at a plurality of different locations on the occupant's body. See, for example, FIGS. 6 and 7.

Accordingly, in examples, the method 400 may comprise determining the heat flux 12 from or to an occupant 14 of a seat 16 at a first location 48 of an occupant's body 50, determining the heat flux 12 from or to the occupant 14 of a seat 16 at a second, different location 56 on the occupant's body, controlling first heating means 18 and/or first cooling means 20 in dependence upon the first heat flux 12 and controlling second heating means 18 and/or cooling means 20 in dependence upon the second heat flux 12.

That is, in examples, a plurality of heat flux sensors 21 may be used to measure the heat flux 12 from the occupant 14 of the seat 16 at different locations on the occupant's body to allow for finer control of the heat flux 12 from the occupant 14.

FIG. 5 illustrates an example of a system 60.

In the example of FIG. 5, the system 60 comprises a heat flux sensor 21, which in the illustrated example is a conductive heat flux sensor 28, and two combined heating and cooling means 18, 20.

In the example of FIG. 5, these elements are located in a seat 16 and are communicatively coupled to a system 10 which may be as the system 10 described in relation to FIGS. 1 and/or 2.

In FIG. 5, the heat flux sensor 21 is located in the seat cushion portion of the seat 16 and a first combined heating and cooling means 18, 20 is located underneath the heat flux sensor 21 in the seat cushion portion of the seat 16. A second, different combined heating and cooling means 18, 20 is located in the backrest of the seat 16.

The system 60 illustrated in FIG. 5 may be for performing/perform the method 300 of FIG. 3 or the method 400 of FIG. 4.

For example, a person may sit on the seat 16 of FIG. 5 and become an occupant 14 of the seat 16.

The heat flux sensor 21 may measure the heat flux 12 from the occupant 14 into the seat 16 and the heating means 18 and/or cooling means 20 may be controlled in dependence on the determined heat flux 12 from or to the occupant 14 of the seat 16.

In examples the heating means 18 and/or cooling means 20 may be controlled upon detection that the seat 16 has become occupied and in dependence on the measured heat flux 12.

Additionally or alternatively if it is determined that the occupant 14 leaves the seat 16 a different thermal regulation strategy may be adopted. For example, the heating means 18 and/or cooling means 20 may be used minimally or deactivated to minimize wasted energy consumption.

FIG. 6 illustrates an example of a system 60. In the example of FIG. 6, the system 60 is in a vehicle 22.

In FIG. 6 a person is an occupant 14 of a seat 16 and is controlling the vehicle 22 using a steering wheel.

The seat 16 is similar to the seat illustrated in the example of FIG. 5 but comprises a heat flux sensor 21, which in the example is a conductive heat flux sensor 28, for each of the combined heating and cooling means 18, 20.

That is, in the example of FIG. 6 there is also a heat flux sensor 21 in the backrest portion of the seat 16.

The system 10 for controlling the system 60 is not illustrated in the example of FIG. 6.

In the example of FIG. 6, the occupant 14 has provided an initiation signal to the system 60 to provide heat as it is a cold day and the occupant 14 feels cold.

This is illustrated in the example of FIG. 6 by the arrows indicating heat flux 12 from the heating means 18 to the occupant 14.

The system 60 of FIG. 6 may operate similarly as the system 60 described in relation to FIG. 5. However, in the system of FIG. 6, the different combined heating and cooling means 18, 20 may be controlled independently of each other in dependence upon the heat flux measurement from their associated heat flux sensors 21.

For example, in the example of FIG. 6, following the initial heating period, the heat flux sensor 21 in the backrest may determine a smaller heat flux 12 than the heat flux sensor 21 in the seat cushion and therefore the heating and cooling means 18, 20 in the backrest of the seat 16 may be controlled to be cooler than the heating and cooling means 18, 20 in the seat cushion.

FIG. 7 illustrates an example of a system 60. In the example of FIG. 7, the system 60 is in a vehicle 22.

The example illustrated in FIG. 7 is similar to that illustrated in FIG. 6. However, in the example of FIG. 7, the system 10 is illustrated.

Additionally, in the example of FIG. 7, the system 60 comprises a further heat flux sensor 21, which in the example is a conductive heat flux sensor 28, in the steering wheel of the vehicle 22. Furthermore, an additional combined heating and cooling means 18, 20 is also provided in the steering wheel of the vehicle 22 and is associated with the heat flux sensor 21 in the steering wheel.

In the example of FIG. 7, the three combined heating and cooling means 18, 20 may be controlled independently of each other in dependence upon the heat flux 12 from an occupant 14 of the seat 16 determined at the three separate heat flux sensors 21.

In addition, the system 60 of FIG. 7 comprises two additional sensors 34. A first additional sensor on the dashboard of the vehicle 22 which, in the example, is a solar sensor for enabling determining or estimation of radiant energy flux to an occupant 14 of the seat 16.

The second additional sensor 34 located adjacent the seat 16 is, in the example, an air sensor for enabling measurement or estimation of convective energy flux to an occupant 14 of the seat 16.

In the example of FIG. 7, the heating means 18 and cooling means 20 may be controlled in dependence upon signals received from the additional sensors 34 which enable measurement or estimation or radiant flux and convective energy flux to an occupant 14 of the seat 16.

Also illustrated in the example of FIG. 7 is a vehicle control system 76 which in the illustrated example is the heating ventilation and air conditioning (HVAC) control system. The system 10 is communicatively coupled to the HVAC system 76 and may control the HVAC system 76 to provide additional heating and/or cooling if there is a deficit with regard to the heating and/or cooling that can be provided by the heating means 18 and cooling means 20. It should be noted however that, in examples, the HVAC system 76 may be considered heating means 18 and cooling means 20 of the system 60.

For example, if it is a particularly sunny and hot day, the combined heating and cooling means 18, 20 in the seat 16 and steering wheel of the vehicle 22 may not be sufficient to provide comfortable heat dissipation for an occupant 14 of the seat 16. In such examples, the HAVC system 76 may be controlled by the system 10 to provide additional cooling to an occupant 14 of the seat 16 to cover the deficit.

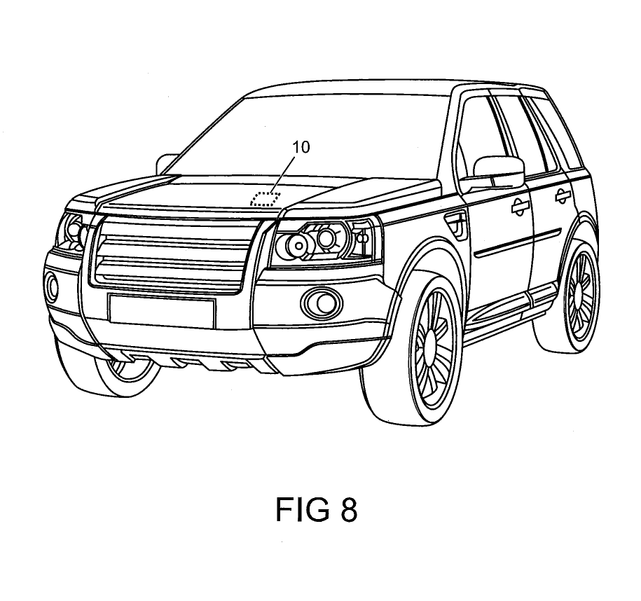

FIG. 8 illustrates an example of a vehicle 22. The vehicle 22 comprises a system 10 as described in relation to FIG. 1. In examples the vehicle 22 of FIG. 8 may comprise a system 60 as described in relation to FIG. 2.

As used herein, “for” should be considered to also include “configured or arranged to”. For example, “a system for” should be considered to also include “a system configured or arranged to”.

Various parts of this disclosure recite controlling actions such as controlling measuring and so on. The present disclosure is also intended to include initiating and also performing such actions. For example, controlling measuring is intended to also disclose initiating measuring and also measuring.

Examples of the present disclosure provide a number of advantages. For example, examples of the present disclosure provide for efficient and more predictable thermal control of an occupant 14 of a seat 16.

For purposes of this disclosure, it is to be understood that the controller(s) described herein can each comprise a control unit or computational device having one or more electronic processors. A vehicle and/or a system thereof may comprise a single control unit or electronic controller or alternatively different functions of the controller(s) may be embodied in, or hosted in, different control units or controllers. A set of instructions could be provided which, when executed, cause said controller(s) or control unit(s) to implement the control techniques described herein (including the described method(s)). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on or more electronic processors, optionally the same one or more processors as the first controller. It will be appreciated, however, that other arrangements are also useful, and therefore, the present disclosure is not intended to be limited to any particular arrangement. In any event, the set of instructions described above may be embedded in a computer-readable storage medium (e.g., a non-transitory storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM ad EEPROM); flash memory; or electrical or other types of medium for storing such information/instructions.

The blocks illustrated in the FIGS. 3 and 4 may represent steps in a method and/or sections of code in the computer program 62. The illustration of a particular order to the blocks does not necessarily imply that there is a required or preferred order for the blocks and the order and arrangement of the block may be varied. Furthermore, it may be possible for some steps to be omitted.

Where a structural feature has been described, it may be replaced by means for performing one or more of the functions of the structural feature whether that function or those functions are explicitly or implicitly described.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A system comprising a processor configured to:
determine heat flux from or to an occupant of a seat;
determine a required heat dissipation for the occupant of the seat from one or more sensor measurements of the occupant of the seat; and
control a heating device and/or a cooling device in dependence upon the determined heat flux from or to the occupant of the seat and the determined required heat dissipation for the occupant of the seat.

2. The system as claimed in claim 1, wherein the seat is in a vehicle and the occupant is an occupant of the vehicle.

3. The system as claimed in claim 1, wherein the processor is further configured to receive at least one signal from at least one conductive heat flux sensor, the at least one signal comprising information to enable the processor to determine, at least, conductive heat flux from or to the occupant of the seat.

4. The system as claimed in claim 3, wherein the processor is further configured to receive at least one signal from at least one additional sensor.

5. The system as claimed in claim 4, wherein the at least one signal from the at least one additional sensor comprises information to enable the processor to determine radiant energy flux and/or to determine convective energy flux from or to the occupant of the seat.

6. The system as claimed in claim 5, wherein the processor is further configured to control the heating device and/or the cooling device in dependence upon, at least, the conductive heat flux from or to the occupant of the seat and the radiant energy flux and/or convective energy flux from or to the occupant of the seat.

7. The system as claimed in claim 1, wherein the processor is further configured to control the heating device and/or the cooling device to provide initial heating and/or cooling to the occupant of the seat prior to the heating device and/or the cooling device being controlled in dependence upon the determined heat flux from or to the occupant of the seat.

8. The system as claimed in claim 7, wherein the processor is further configured to receive at least one initiation control signal, wherein the processor is further configured to control the heating device and/or the cooling device to provide the initial heating and/or cooling in dependence upon the at least one initiation control signal.

9. The system as claimed in claim 1, wherein the processor is further configured to:
receive at least one first signal from a first heat flux sensor, the at least one first signal comprising information to enable a first heat flux from or to the occupant at a first location on the occupant's body to be determined;
receive at least one second signal from a second heat flux sensor, the at least one second signal comprising information to enable a second heat flux from or to the occupant at a second, different location on the occupant's body to be determined;
control the heating device and/or the cooling device in dependence upon the first heat flux, and control a second heating device and/or a second cooling device in dependence upon the second heat flux.

10. The system as claimed in claim 1, wherein the processor is configured to determine the heat flux from or to an occupant of a seat by controlling measuring of the heat flux from or to an occupant of a seat.

11. The system as claimed in claim 1, wherein the heating device and/or the cooling device are configured to heat and/or cool at least one surface of a vehicle.

12. A vehicle control system comprising at least one system as claimed in claim 1.

13. A vehicle comprising at least one system as claimed in claim 1.

14. A method comprising:
determining heat flux from or to an occupant of a seat;
determining a required heat dissipation for the occupant of the seat from one or more sensor measurements of the occupant of the seat; and
controlling a heating device and/or a cooling device in dependence upon the determined heat flux from or to the occupant of the seat and the determined required heat dissipation for the occupant of the seat.

15. The method as claimed in claim 14, wherein the seat is in a vehicle and the occupant is an occupant of the vehicle.

16. The method as claimed in claim 14 or 15, further comprising receiving at least one signal from at least one conductive heat flux sensor, the at least one signal comprising information to enable determining of, at least, conductive heat flux from or to the occupant of the seat.

17-19. (canceled)

20. The method as claimed in claim 14, further comprising controlling the heating device and/or the cooling device to provide initial heating and/or cooling to the occupant of the seat prior to controlling the heating device and/or the cooling device in dependence upon the determined heat flux from or to the occupant of the seat.

21. (canceled)

22. The method as claimed in claim 14, further comprising:
receiving at least one first signal from a first heat flux sensor, the at least one first signal comprising information to enable a first heat flux from or to the occupant at a first location on the occupant's body to be determined;
receiving at least one second signal from a second heat flux sensor, the at least one second signal comprising information to enable the heat flux from or to the occupant at a second, different location on the occupant's body to be determined;
controlling the heating device and/or the cooling device in dependence upon the first heat flux; and
controlling a second heating device and/or a second cooling device in dependence upon the second heat flux.

23-25. (canceled)

26. A non-transitory computer readable medium having stored thereon a computer program comprising instructions that, when executed by one or more processors, cause the one or more processors to:
determine heat flux from or to an occupant of a seat;
determine a required heat dissipation for the occupant of the seat from one or more sensor measurements of the occupant of the seat; and
control a heating device and/or a cooling device in dependence upon the determined heat flux from or to the occupant of the seat and the determined required heat dissipation for the occupant of the seat.

27. A non-transitory computer readable medium having stored thereon a computer program comprising instructions that, when executed by one or more processors, cause the one or more processors to perform, at least, the method as claimed in claim 14.

28-30. (canceled)
